(19) United States
(12) Patent Application Publication
(10) Pub. No.: US 2019/0161931 A1
(43) Pub. Date: May 30, 2019

(54) WATER FLOW CONTROL GROUND COVER

(71) Applicant: Watershed Geosynthetics LLC, Alpharetta, GA (US)

(72) Inventors: Bradford H. Cooley, Chattanooga, TN (US); Michael R. Ayers, Johns Creek, GA (US)

(73) Assignee: Watershed Geosynthetics LLC, Alpharetta, GA (US)

(21) Appl. No.: 16/203,451

(22) Filed: Nov. 28, 2018

Related U.S. Application Data
(60) Provisional application No. 62/591,404, filed on Nov. 28, 2017.

(51) Int. Cl. E02B 3/12; B32B 5/26; B32B 5/06; D04H 1/4374; D04H 1/58

(52) U.S. Cl. CPC E02B 3/126; B32B 5/26; B32B 5/06; B32B 2250/02; D04H 1/58; B32B 2250/20; D04H 1/4374

(57) ABSTRACT

A ground cover is disclosed having a non-woven layer or mat of randomly oriented polymeric fibers coupled to an underlying porous or water permeable geomembrane or base layer of a polymeric material. The ground cover may include tufts or strands of the synthetic turf or grass bonded to the base layer.

### CROSS REFERENCE TO RELATED APPLICATIONS

Applicant claims the benefit of U.S. Provisional Patent Application Ser. No. 62/591,404 filed Nov. 28, 2017 and entitled “WATER FLOW CONTROL GROUND COVER”.

### TECHNICAL FIELD

This invention relates generally to ground covers used in covering large areas of ground selectively to prevent or to regulate water infiltration and/or wind erosion. More particularly, the present invention relates to ground covers providing water flow control while covering large areas of ground for optionally restricting water infiltration into the ground or facilitating water infiltration into a ground water table below.

In this application, the following terms will be understood to have the indicated definitions.

“tufted geosynthetics”—a cover system which is generally comprised of synthetic grass having synthetic fibers tufted to a backing and a geomembrane and which is adapted to cover waste sites and other environmental closures. Examples of a tufted geosynthetic cover system are shown in Ayers and Urrutia U.S. Pat. Nos. 7,682,105 and 9,163,375. The term “tufted geosynthetics” is also used to refer to a synthetic turf cover system.

“waste sites”—refers to sites where waste is deposited, such as commercial and industrial landfills, phosphogypsum stacks, coal ash landfills, environmentally impacted land, leach pads, mining spoils and environmental closures or material stockpiles that require a closure system.

“synthetic grass”—refers to a composite which comprises at least one geotextile (woven or nonwoven) tufted with one or more synthetic yarns or strands and which has the appearance of grass.

“geomembrane”—refers to a polymeric material, such as high density polyethylene, very low density polyethylene, linear low density polyethylene, polyvinyl chloride, etc., which polymeric material may be textured or smooth.

“sloping ground”—refers to ground which is not level, but has an angle of slope.

“environmental water”—refers to water occurring at a landsite, such as rainfall, snow melt, and storm water runoff.

“nonwoven textile” refers to fabric, sheet or web structures bonded together by entangling fiber or filaments (and by perforating films) mechanically, thermally, solvent or chemically, which structures are flat or tufted porous sheets or fabric-like materials made directly from separate staple fibers (short) and long fibers (continuous long) of polymeric materials, molten plastic or plastic film, held together by chemical, mechanical, heat, or solvent treatment.

### BACKGROUND OF THE INVENTION

Coverings have been used to overlay large areas of ground including landfills, waste sites, manufacturing laydown sites, and stockpiles. Some ground covers are used to shed water and prevent the environmental water from infiltration through the site and being absorbed into the soil which may allow contaminates into the soil. A common problem with such water shedding ground covers is that the accumulation of large amounts of water such as from heavy or sustained rain fall results in large volumes of water moving swiftly and rapidly across the ground cover and particularly across the steep slopes often present in covered landfills, waste sites and stockpiles. The large volume flow and velocity may cause damage to the ground surrounding the cover as the fast moving water moves from the cover to the surrounding ground.

These types of ground covers accordingly prevent erosion by restricting wind action and allowing clean water to flow off of the covered site rather than percolate or infiltrate for absorption into the underlying soil. These types of ground covers may be relatively expensive to manufacture, install, and maintain.

However, while these ground covers accomplish water shedding and restrict infiltration such as through landfills and stockpiles, a need exists in arid regions for permitting clean water to infiltrate below ground into ground water tables. Heavy rains and high volume of water in arid land often moves rapidly away to stream beds and downstream. Much of the available water thus fails to enter the ground water table.

Accordingly, it is seen that a need remains for a ground cover which may be formed to slow water flow across the ground cover for a purpose of either (a) shedding the water from the cover to a collector or (b) absorbing the water as an infiltrant into the soil below, yet is easy and cost effective to manufacture, install, and maintain. It is to the provision of such that the present invention is primarily directed.

### SUMMARY OF THE INVENTION

The present invention meets the need in the art for a water flow control ground cover. Briefly described, the present invention provides a new and improved water flow control ground cover for use in conjunction with large areas of land, such as a ground cover comprising a non-woven layer or mat of randomly oriented polymeric fibers coupled to an underlying base layer of a polymeric material that is optionally (a) porous or water permeable or (b) impervious or water impermeable. The ground cover may also include synthetic grass or turf incorporated into and extending from the non-woven mat as grass-like blades.

Objects, advantages, and features of the present invention may be readily determined upon a reading of the following detailed description in conjunction with the drawings and the appended claims.

### BRIEF DESCRIPTION OF THE DRAWING

FIG. 1 is a perspective view of a ground cover in a preferred form of the invention.

FIG. 2 is a perspective view of a ground cover in another preferred form of the invention.

FIG. 3 is a perspective view of a ground cover in another preferred form of the invention.

FIG. 4 is a perspective view of a ground cover in yet another preferred form of the invention.

### DETAILED DESCRIPTION

### First Embodiment

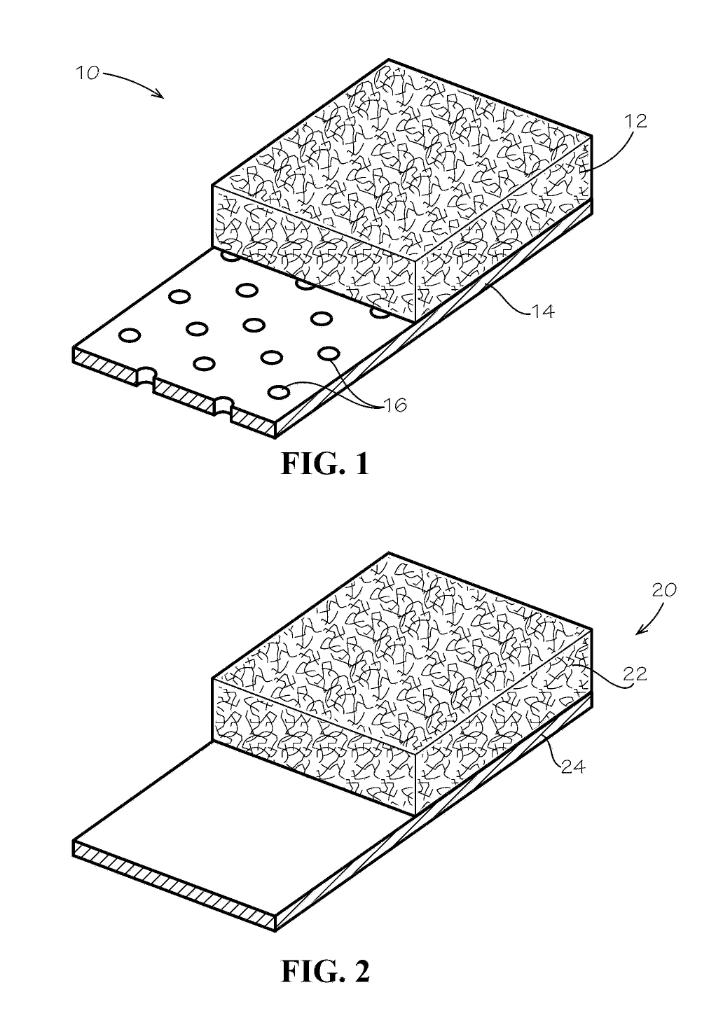

With reference next to the drawings, there is shown in FIG. 1 a ground cover 10 embodying principles of the invention in a preferred form. The ground cover 10 has a non-woven layer, mass or mat 12 of randomly oriented thermoplastic fibers, which may be a spunbond polyethylene, polypropylene, polyolefin, or other non-woven textile. The mat 12 may have a density of between about 2 ounces/square yard and about 60 ounces/square yard. The non-woven mat 12 is coupled to an underlying porous or water permeable geomembrane or base layer 14 of a thermoplastic material. In the illustrated embodiment, the mat 12 is a lofted air-laid non-woven textile.

The base layer 14 may be one or more layers of a woven material made of polypropylene, polyethylene or polymerizing vinyl chloride (PVC). Alternatively, the base layer 14 may be a flexible, sprayed upon layer of polypropylene or polyethylene which when cured includes pores or interstices 16 such as by punching or molding and that allow the passage of water therethrough. Also, alternatively, the base layer 14 may be a thermoplastic or polymeric film. The thickness of the base layer 14 may be approximately 5 mils to about 60 mils. Such base layers 14 are sometimes referred to as a geomembrane.

In use, the ground cover 10 is positioned over or upon a tract of land wherein it is desired to have environmental water such as rainfall, snow melt, or storm water runoff seep or infiltrate into the soil. As water falls upon the ground covering 10, the water seeps, percolates or travels through the non-woven mat 12. The non-woven mat 12 slows down the flow rate or rate of travel of the water therethrough and thus slows the flow across, through and over the ground cover, resulting in the water having a longer dwell time and increasing the capability of the water on the cover to pass from the non-woven mat 12 through the porous base layer 14 and into the underlying soil. Additionally, the non-woven mat 12 works very well in disturbing wind flow over the ground cover 10 and reducing the uplift forces upon the base layer 14.

The sizing of the pores or interstices 16 should be selected to allow the flow of water through the base layer 14 by being large enough so as not to prevent the flow through the base layer as a result of the water tension within the pores.

### Second Embodiment

With reference next to the drawings, there is shown in FIG. 2 a ground cover 20 embodying principles of the invention in another preferred form. The ground cover 20 has a non-woven layer or mat 22 of randomly oriented thermoplastic fibers, which may be a spunbond polyethylene, polypropylene, polyolefin, or other non-woven textile. The mat 22 may have a density of between about 2 ounces/square yard and about 60 ounces/square yard. The non-woven mat 22 is coupled to an underlying non-porous or water impermeable geomembrane or base layer 24 of thermoplastic material. In the illustrated embodiment, the mat 22 is a lofted air-laid non-woven textile.

The base layer 24 may be one or more layers of a woven material made of polypropylene, polyethylene or polymerizing vinyl chloride (PVC). Alternatively, the base layer 24 may be a flexible, sprayed-upon layer of polypropylene or polyethylene which when cured does not include pores or interstices and thus the base layer 24 restricts or blocks a passage of water therethrough, i.e., a solid layer which is substantially pore free. Also, alternatively, the base layer 24 may be a thermoplastic or polymeric film. The thickness of the base layer 24 may be approximately 5 mils to about 60 mils. Such base layers 24 are sometimes referred to as a geomembrane.

In use, the ground cover 20 is positioned over or upon a tract of land, landfill, waste site, or stockpile, wherein it is not desired to have environmental water seep through and infiltrate into the soil. As environmental water such as rainfall, snow melt, and storm water runoff falls upon or flows over the ground covering 20, the water seeps, peculates or travels through the non-woven mat 22. The non-woven mat 22 slows down the flow rate or rate of travel of the water therethrough and thus slows the flow across, through and over the ground cover so as to reduce the water speed as it leaves the ground cover 20 and flows to a collector or onto the surrounding land. Additionally, the non-woven mat 22 works very well in disturbing wind flow over the ground cover 20 and reducing the uplift forces upon the base layer 24.

As the base layer 24 is water impermeable, this embodiment does not allow water to seep through the ground cover 20 and into the underlying ground. As such, all water is shed to the surrounding area.

### Third Embodiment

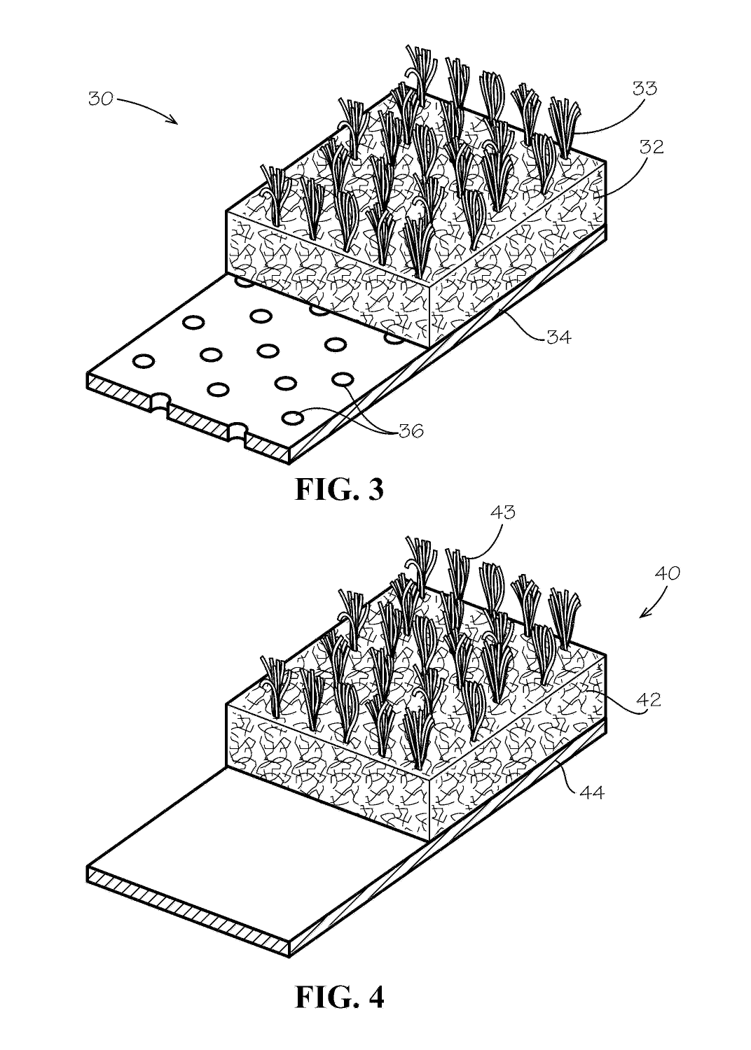

With reference next to the drawings, there is shown in FIG. 3 a ground cover 30 embodying principles of the invention in another preferred form. The ground cover 30 has a non-woven layer or mat 32 of randomly oriented thermoplastic or polymeric fibers, which may be a spunbond polyethylene, polypropylene, polyolefin, or other non-woven textile. The mat 32 may have a density of between about 2 ounces/square yard and about 60 ounces/square yard. The non-woven mat 32 is coupled to an underlying porous or water permeable geomembrane or base layer 34 of thermoplastic material. In the illustrated embodiment, the mat 32 is a lofted air-laid non-woven textile.

The non-woven mat 32 also includes an array or mass of synthetic turf, strands, or blades 33. The synthetic turf 33 may be formed by any conventional means such as tufting of yarns through the non-woven mat or weaving tufts or lines of tufts of synthetic fibers or yarn into the non-woven mat. Preferably, the synthetic turf, blades or strands 33 are slender elongate elements. As used herein, “slender” indicates a length that is much greater than its transverse dimension(s). Examples of slender elongate elements contemplated as encompassed by the present invention or in conjunction therewith are structures that resemble blades of grass, rods, filaments, tufts, follicle-like elements, fibers, narrow cone-shaped elements, etc. The synthetic strands extend upwardly from a base field of such strands. Such can simulate a field of grass, pine straw or similar.

Preferably, the chemical composition of the synthetic grass strands 33 should be selected to be heat-resistant and UV-resistant (to withstand exposure to sunlight, which generates heat in the strands and contains ultraviolet rays), and fire-retardant. Furthermore, the polymer yarns of the strands 33 should not become brittle when subjected to low temperatures. The selected synthetic grass color and texture should be aesthetically pleasing. While various other materials may work well for the grass strands, it is presently believed that polyethylene fibers work best.

Optionally, the synthetic grass strands 33 are tufted to have a density of between about 5 ounces/square yard and about 60 ounces/square yard. Preferably, the synthetic grass strands have a density of between about 10 and 40 ounces/square yard. The tufting is fairly homogeneous. In general, a “loop” is inserted at a gauge spacing to achieve the desired density. Each loop shows as two blades of grass at each tufted location. Preferably, the synthetic grass strands have a thickness of at least about 50 microns. The synthetic grass strands 33 have a length of about ½ inch to about 4 inches.

The base layer 34 may be one or more layers of a woven material made of polypropylene, polyethylene or polymerizing vinyl chloride (PVC). Alternatively, the base layer 34 may be a flexible, sprayed upon layer of polypropylene or polyethylene which when cured includes pores or interstices 36 formed such as by punching or molding, which allow the passage of water therethrough. Also, alternatively, the base layer 34 may be a thermoplastic or polymeric film. The thickness of the base layer 34 may be approximately 5 mils to about 60 mils. Such base layers 34 are sometimes referred to as a geomembrane.

The tufts or strands of the synthetic turf or grass 33 (i.e., on the underside) are bonded to the base layer 34 (or to the non-woven mat 32), such as by mechanical means, chemical means, thermal bonding, an adhesive, etc. An example of bonding is by welding with heat and pressure. Another example is the sprayed-upon base layer 34 that seals a bottom for the non-woven mat 32.

In use, the ground cover 30 is positioned over or upon a tract of land wherein it is desired to have environmental water such as rainfall seep or infiltrate into the soil. As environmental water falls upon or passes over the ground covering 30, the water seeps, percolates or travels through the non-woven mat 32. The non-woven mat 32 slows down the flow rate or rate of travel of the water over and through the ground cover, resulting in the water having a longer dwell time and increasing the capability for the water to pass from the non-woven mat 32 through the porous base layer 34 and into the underlying soil. Additionally, the non-woven mat 32 works very well in disturbing wind flow over the ground cover 30 and reducing the uplift forces upon the base layer 34.

The sizing of the pores or interstices 16 should be selected to allow the flow of water from the non-woven mat 32 through the base layer 34 by being large enough so as not to prevent the flow through the base layer as a result of the water tension within the pores.

The additional synthetic turf 33 aids in slowing the flow of water as well as providing a pleasant appearance to the ground cover.

### Fourth Embodiment

With reference next to the drawings, there is shown in FIG. 4 a ground cover 40 embodying principles of the invention in another preferred form. The ground cover 40 has a non-woven layer or mat 42 of randomly oriented thermoplastic fibers, which may be a spunbond polyethylene, polypropylene, polyolefin, or other lofted/air laid non-woven textile. The mat 42 may have a density of between about 2 ounces/square yard and about 60 ounces/square yard. The non-woven mat 42 is coupled to an underlying non-porous or water impermeable geomembrane or base layer 44 of thermoplastic material. In the illustrated embodiment, the mat 42 is a lofted air-laid non-woven textile.

The non-woven mat 42 also includes an array or mass of synthetic turf, strands, or blades 43. The synthetic turf 43 may be formed by any conventional means such as tufting of yarns through the non-woven mat or weaving tufts or lines of tufts of synthetic fibers or yarn into the non-woven mat. Preferably, the synthetic strands 43 are slender elongate elements. As used herein, “slender” indicates a length that is much greater than its transverse dimension(s). Examples of slender elongate elements contemplated as encompassed by the present invention or in conjunction therewith are structures that resemble blades of grass, rods, filaments, tufts, follicle-like elements, fibers, narrow cone-shaped elements, etc. The synthetic strands extend upwardly from a base field of such strands. Such can simulate a field of grass, pine straw or similar.

Preferably, the chemical composition of the synthetic grass strands 43 should be selected to be heat-resistant and UV-resistant (to withstand exposure to sunlight, which generates heat in the strands and contains ultraviolet rays), and fire-retardant. Furthermore, the polymer yarns of the strands 43 should not become brittle when subjected to low temperatures. The selected synthetic grass color and texture should be aesthetically pleasing. While various other materials may work well for the grass strands, it is presently believed that polyethylene fibers work best.

Optionally, the synthetic grass strands 43 are tufted to have a density of between about 5 ounces/square yard and about 60 ounces/square yard. Preferably, the synthetic grass strands have a density of between about 10 and 40 ounces/square yard. The tufting is fairly homogeneous. In general, a “loop” is inserted at a gauge spacing to achieve the desired density. Each loop shows as two blades of grass at each tufted location. Preferably, the synthetic grass strands have a thickness of at least about 50 microns. The synthetic grass strands 43 have a length of about ½ inch to about 4 inches.

The base layer 44 may be one or more layers of a sheet or a woven sheet of material made of polypropylene, polyethylene or polymerizing vinyl chloride (PVC). Alternatively, the base layer 44 may be a flexible, sprayed upon layer of polypropylene or polyethylene which when cured does not include pores or interstices and thus restricts or blocks the passage of water therethrough, i.e., a solid layer which is substantially pore free. Also, alternatively, the base layer 44 may be a thermoplastic or polymeric film. The thickness of the base layer 44 may be approximately 5 mils to about 60 mils. Such base layers 44 are sometimes referred to as a geomembrane.

The tufts or strands of the synthetic turf or grass 43 (i.e., on the underside) are bonded to the base layer 44 (or to the non-woven mat 42), such as by mechanical means, chemical means, thermal bonding, an adhesive, etc. An example of bonding is by welding with heat and pressure. Another example is the sprayed-upon base layer 44 that seals a bottom for the non-woven mat 42.

In use, the ground cover 40 is positioned over or upon a tract of land, landfill, waste site, or stockpile wherein it is desired to restrict or prevent seepage or infiltration of environmental water such as rainfall, snow melt, or storm water, into the soil. As water falls upon or passes over the ground covering 40, the water seeps, percolates or travels through the non-woven mat 42. The non-woven mat 42 slows down the movement or flow rate or rate of travel of the water over the ground cover and through mat so as to reduce the water speed as it moves along the ground cover 40 and flows for example to collectors or onto the surrounding land. Additionally, the non-woven mat 42 works very well in disturbing wind flow over the ground cover 40 and reducing the uplift forces up the base layer 44.

The additional synthetic turf 43 aids in slowing the flow of water as well as providing a pleasant appearance to the ground cover.

As the base layer 44 is water impermeable, this embodiment does not allow water to seep through the ground cover 40 and into the underlying ground. As such, all water is shed to the surrounding area.

Thus, it should be understood that a new water flow control ground cover is described which includes a non-woven layer or mat of randomly oriented thermoplastic fibers coupled to an underlying base layer of thermoplastic material that is optionally (a) porous or water permeable or (b) impervious or water impermeable. The ground cover may also include synthetic grass, strands, blades or turf incorporated into and extending from the non-woven mat.

It thus is seen that a ground cover is now provided which aids in slowing the flow of water through and over the ground cover while either allowing for the seepage of water into the ground or not based on the soil and water requirements (i.e., allow seepage in arid regions for replenishing ground water tables or restrict seepage as to landfills, waste sites, or stockpiles).

What is claimed is:

1. A water flow control ground cover comprising:
a base layer of a polymeric material, and
a mat of randomly oriented polymeric fibers coupled to said base layer.

2. The water flow control ground cover of claim 1 wherein said base layer is a water impervious base layer.

3. The water flow control ground cover of claim 1 wherein said base layer is a water permeable base layer.

4. The water flow control ground cover of claim 1 further comprising a plurality of synthetic turf strands.

5. The water flow control ground cover of claim 4 wherein said plurality of synthetic turf strands are coupled to said base layer.

6. The water flow control ground cover of claim 4 wherein said plurality of synthetic turf strands have a density of between 5 ounces per square yard and 60 ounces per square yard.

7. The water flow control ground cover of claim 1 wherein said mat has a density of between 2 ounces per square yard and 60 ounces per square yard.

8. The water flow control ground cover of claim 1 wherein said base layer has a thickness of approximately 5 mils to about 60 mils.

9. The water flow control ground cover of claim 1 wherein said mat of randomly oriented polymeric fibers is a non-woven textile.

10. The water flow control ground cover of claim 1 wherein said mat of randomly oriented polymeric fibers is a plurality of non-woven polymeric fibers.

11. A water flow control ground cover comprising:
a geomembrane of polymeric material, and
a mass of randomly oriented polymeric fibers coupled to said geomembrane.

12. The water flow control ground cover of claim 11 wherein said geomembrane is a water impervious geomembrane.

13. The water flow control ground cover of claim 11 wherein said geomembrane is a water permeable geomembrane.

14. The water flow control ground cover of claim 11 further comprising a plurality of synthetic turf strands.

15. The water flow control ground cover of claim 14 wherein said plurality of synthetic turf strands are coupled to said geomembrane.

16. The water flow control ground cover of claim 14 wherein said plurality of synthetic turf strands have a density of between 5 ounces per square yard and 60 ounces per square yard.

17. The water flow control ground cover of claim 14 wherein said mass has a density of between 2 ounces per square yard and 60 ounces per square yard.

18. The water flow control ground cover of claim 14 wherein said base layer has a thickness of approximately 5 mils to about 60 mils.

19. The water flow control ground cover of claim 11 wherein said mass of randomly oriented polymeric fibers is a non-woven textile.

20. The water flow control ground cover of claim 11 wherein said mass of randomly oriented polymeric fibers is a plurality of non-woven thermoplastic fibers.

21. A water flow control ground cover comprising:
a base layer;
a mat of randomly oriented fibers coupled to said base layer, and
a plurality of synthetic grass blades.

22. The water flow control ground cover of claim 21 wherein said base layer is a water impervious base layer.

23. The water flow control ground cover of claim 21 wherein said base layer is a water permeable base layer.

24. The water flow control ground cover of claim 21 wherein said plurality of synthetic grass blades are coupled to said base layer.

25. The water flow control ground cover of claim 21 wherein said plurality of synthetic grass blades have a density of between 5 ounces per square yard and 60 ounces per square yard.

26. The water flow control ground cover of claim 21 wherein said mat has a density of between 2 ounces per square yard and 60 ounces per square yard.

27. The water flow control ground cover of claim 21 wherein said base layer has a thickness of approximately 5 mils to about 60 mils.

28. The water flow control ground cover of claim 21 wherein said mat of randomly oriented fibers is a non-woven textile.

29. The water flow control ground cover of claim 21 wherein said mat of randomly oriented fibers is a mat of non-woven polymeric fibers.
